(19) United States
(12) Patent Application Publication
(10) Pub. No.: US 2009/0246603 A1
(43) Pub. Date: Oct. 1, 2009

(54) PROCESS FOR RECLAIMING A CONTAMINATED ELECTROLYTE FROM AN ELECTROLYTIC CELL USED IN THE PRODUCTION OF GASEOUS FLUORINE

(75) Inventors: Per G. Ekevag, Paducah, KY (US); Jon B. Price, Paducah, KY (US); David M. Craig, Paducah, KY (US); Shane L. Robinson, Benton, KY (US); Kent C. Beckman, Paducah, KY (US); Allen Greenwell, Paducah, KY (US); Richard R. Travis, Murry, KY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell, Inc.

(21) Appl. No.: 12/056,839

(22) Filed: Mar. 27, 2008

(51) Int. Cl. H01M 6/50; H01M 10/44; H01M 6/52

(52) U.S. Cl. 429/49; 429/50; 210/513

(57) ABSTRACT

A process for reclaiming a contaminated electrolyte in an electrolytic cell used in the production of gaseous fluorine. The contaminated electrolyte is a mixture of potassium bifluoride and hydrofluoric acid having metal ions therein. The process has the following steps: a) removing the contaminated electrolyte from the cell to a treatment tank; b) adding a lithium compound to the contaminated electrolyte in the treatment tank to induce settlement of at least part of the metal ions; c) allowing the metal ions to settle to the bottom of the treatment tank; d) removing the settled metal ions from the bottom of the treatment tank to form a reclaimed electrolyte; and e) returning the reclaimed electrolyte to the cell.

### BACKGROUND OF THE INVENTION

1. Field of the Invention

The present invention relates to a process for reclaiming electrolyte from an electrolytic cell used in the production of gaseous fluorine.

2. Description of the Related Art

Gaseous fluorine (F₂) is manufactured from the splitting of hydrofluoric acid (HF) (with gaseous hydrogen (H₂) as the other product). Splitting takes place in an electrolytic cell. Each cell typically contains a liquid electrolyte of a mixture of potassium bifluoride (KHF₂) and HF commonly referred to as a “melt”. Electricity is passed through the liquid electrolyte to form the products.

During operation of an electrolytic cell, metal components in the cell body and head of the cell corrode over time to form ions, which become dissolved and/or suspended in the melt. Iron ions are the most common. When the level of metal ions in the electrolyte reaches about 1 wt % (based on the total weight of the electrolyte), cell performance begins to deteriorate. At 2 wt %, performance is compromised to an extent that the electrolyte is normally discarded and the cell replenished with new electrolyte.

One method employed in the industry to address the problem of ion contamination in the electrolyte is to add a source of lithium ions (obtained from, for example, LiF). Lithium ions cause ions of other metals, including iron ions, to settle.

One problem encountered in commercial processes is that the excess use of lithium ions exacerbates corrosion rate within electrolytic cells. Another problem is the disposal of contaminated electrolyte. Contaminated electrolyte must be treated/processed in a waste treatment facility.

It would be desirable to have a process in which contamination in the electrolytic cell could be controlled. It would also be desirable to have a process in which the amount of contaminated electrolyte to be disposed of is reduced.

### SUMMARY OF THE INVENTION

According to the present invention, there is provided a process for reclaiming a contaminated electrolyte in an electrolytic cell used in the production of gaseous fluorine. The contaminated electrolyte is a mixture of potassium bifluoride and hydrofluoric acid having metal ions therein. The process has the following steps: a) removing the contaminated electrolyte from the cell to a treatment tank; b) adding a lithium compound to the contaminated electrolyte in the treatment tank to induce settlement of at least part of and preferably substantially all of the metal ions; c) allowing the metal ions to settle to the bottom of the treatment tank; d) removing the settled metal ions from the bottom of the treatment tank to form a reclaimed electrolyte; and e) returning the reclaimed electrolyte to the cell.

According to the present invention, there is provided a process for generating pollution credits when reclaiming a contaminated electrolyte from an electrolytic cell used in the production of gaseous fluorine.

### DETAILED DESCRIPTION OF THE INVENTION

The electrolyte is primarily made up of the components potassium bifluoride and/or hydrofluoric acid. Potassium bifluoride is typically present from about 58 to about 62 wt % and more typically present from about 59 to about 61 wt %. Hydrofluoric acid is typically present from about 38 to about 42 wt % and more typically present from about 39 to about 41 wt %.

Over the course of time and use, the electrolyte (the melt) of the electrolytic cell becomes contaminated with metal ions. Metal ions typically result from corrosion on the cell body, cell head, other metal components, and other metal contact surfaces within the electrolytic cell. The ions can be from any contact metal in the cell, including those of iron, nickel and magnesium. Iron ions are the most common. The metal Ions are dissolved in the melt.

To reclaim the contaminated electrolyte, the electrolyte is removed, i.e., withdrawn, from the electrolytic cell to a separate treatment tank. A settling agent, a lithium compound, is added to the treatment tank to induce settlement of metal ions. A useful lithium compounds is lithium fluoride (LiF). Metal ions (as well as lithium ions) are allowed to settle to the bottom of the treatment tank.

The settled metal ions are removed from the bottom of the treatment tank in a waste stream and disposed of. Typically, this waste stream will take the form of a slurry-like mixture of settled metal ions in a minor proportion of the decontaminated electrolyte. The waste stream will typically be sent to a waste disposal facility for treatment. The major proportion of the decontaminated electrolyte will be returned to the cell as reclaimed electrolyte. If desired, the reclaimed electrolyte can be removed from the treatment tank to a holding tank for a period of time prior to being returned to the cell. Optionally, potassium bifluoride and/or hydrofluoric acid can be added as necessary to the reclaimed electrolyte to restore content to a desired reference level(s).

The process of the present invention affords a significant reduction in the amount of contaminated electrolyte that normally would have to be sent in its entirety to a waste treatment facility for processing. Using the process of the present invention, typically only about 30% of the electrolyte is lost to waste treatment. Thus, material and waste treatment savings are about 70%.

In addition to material and waste treatment savings, the process of the present invention affords the additional advantage of minimizing lithium content in the electrolytic cell after reclamation of electrolyte. Most lithium ions added to the electrolyte in the treatment tank settle and are removed with other metal ions prior to return of the major proportion of the decontaminated electrolyte (the remainder of the reclaimed electrolyte) to the cell. The proportion of lithium ions in the reclaimed electrolyte is trace. Thus, the exposure of the electrode and contact surfaces in the cell to lithium ions is minimized. Minimizing exposure of the electrode and other metal contact surfaces to lithium ions minimizes the risk of increasing corrosion rates.

Another aspect of the present invention is the use of the process for reclaiming a contaminated electrolyte from an electrolytic cell used in the production of gaseous fluorine as a method for generating pollution credits in view of the amount or proportion of electrolyte reclaimed and not disposed of in a waste treatment facility.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. A process for reclaiming a contaminated electrolyte in an electrolytic cell wherein the contaminated electrolyte is a mixture of potassium bifluoride and hydrofluoric acid having metal ions therein, comprising:
a) removing the contaminated electrolyte from the cell to a treatment tank;
b) adding a lithium compound to the contaminated electrolyte in the treatment tank to induce settlement of at least part of the metal ions;
c) allowing the metal ions to settle to the bottom of the treatment tank;
d) removing the settled metal ions from the bottom of the treatment tank to form a reclaimed electrolyte; and
e) returning the reclaimed electrolyte to the cell.

2. The process of claim 1, wherein the reclaimed electrolyte is removed to a holding tank prior to being returned to the cell.

3. The process of claim 1, wherein the lithium compound is lithium fluoride.

4. The process of claim 1, wherein potassium bifluoride and/or hydrofluoric acid are added to the reclaimed electrolyte to restore content to a desired reference level(s).

5. The process of claim 1, wherein the contaminated electrolyte has about 58 to about 62 wt % potassium bifluoride and about 38 to about 42 wt % of hydrofluoric acid.

6. The process of claim 1, wherein the contaminated electrolyte has about 59 to about 61 wt % potassium bifluoride and about 39 to about 41 wt % of hydrofluoric acid.

7. A method for generating pollution credits in view of the proportion of electrolyte reclaimed using the process of claim 1.
